(19) United States
(12) Patent Application Publication
(10) Pub. No.: US 2019/0155635 A1
(43) Pub. Date: May 23, 2019

(54) HIGH AVAILABILITY SYSTEM FOR PROVIDING IN-MEMORY BASED VIRTUALIZATION SERVICE

(71) Applicant: HANWITH Information Technology Co., Ltd., Seol (KR)

(72) Inventor: Chang Hwan KIM, Gwangmyeong-si, Gyeonggi-do (KR)

(73) Assignee: HANWITH Information Technology Co., Ltd., Seoul (KR)

(21) Appl. No.: 16/192,821

(22) Filed: Nov. 16, 2018

(30) Foreign Application Priority Data
Nov. 20, 2017 (KR) 10-2017-0154727

(51) Int. Cl. G06F 9/455; G06F 3/06

(52) U.S. Cl. CPC G06F 9/45558; G06F 3/0604; G06F 3/0631; G06F 2009/45591; G06F 3/067; G06F 2009/45583; G06F 2009/45579; G06F 3/0664

(57) ABSTRACT

A high availability system for providing an in-memory based virtualization-service, which includes client terminals, a connection broker (CB) manager configured to authenticate the client terminals and authorize the client terminals to connect with a virtualization server, and a virtualization server configured to provide a virtualization service to the connected client terminals.

### CROSS-REFERENCE TO RELATED APPLICATION

This application claims priority from Korean Patent Application No. 10-2017-0154727, filed on Nov. 20, 2017 in the Korean Intellectual Property Office, the disclosure of which is incorporated herein by reference.

### BACKGROUND OF THE INVENTION

### (a) Field of the Invention

The present disclosure relates to a virtualization service providing system, and more particularly to a high availability system for providing an in-memory based virtualization-service, in which data related to client terminals, which includes client virtual machines' individual data and data shared among the client virtual machines and is backed up to a storage of a virtualization server, is migrated to a separate second virtualization server, thereby continuously providing a virtualization service and further improving quality of the virtualization service even when a virtualization server connecting with client terminals fails or the client terminal makes a request for change of the virtualization server.

### (b) Description of the Related Art

In general, a virtualization service providing system includes a plurality of client terminals; a connection broker (CB) manager configured to authenticate client terminals and authorize the client terminals to access a virtualization server; and the virtualization server configured to provide a virtualization service to the accessed client terminals.

A single virtualization server may connect with dozens of client terminals. When dozens of clients are connected to the single virtualization server, the resources of the virtualization server are used as allocated to the client terminals. For example, when a plurality of client terminals is connected to the virtualization server, the resource of the virtualization server, i.e., a storage corresponding to a disk is used as allocated to each individual client terminal.

However, when dozens of client terminals are simultaneously connected to the virtualization server, a load is concentrated on the storage corresponding to the disk, and thus the whole system shows low performance. In particular, the disk is noticeably slower than other resources, e.g., a memory of the virtualization server, and thus more significantly deteriorates the performance.

Meanwhile, connection status and quality are very important for the virtualization service to have continuity of job or work, and it is highly required to keep providing the service until disconnection is normally made.

To improve the quality of the virtualization service, various techniques have been proposed. For example, Korean Patent No. 10-1674619 has proposed “VIRTUALIZED SERVICES PROVIDING SYSTEM FOR PROVIDING SUPERVISORY CONTROL FUNCTION OF CLIENT TERMINAL” to improve virtualization quality.

However, such a related art has proposed no methods of solving the speed-down problem in the storage such as the disk, and seamlessly providing the virtualization service without loss of data, i.e. individual data of client virtual machines currently in use when the virtualization server fails.

### SUMMARY OF THE INVENTION

Accordingly, the present disclosure is conceived to solve the foregoing problems, and an aspect of the present disclosure is to provide a high availability system for providing an in-memory based virtualization-service, in which data related to client terminals, which includes individual client virtual machines' individual data and data shared among the client virtual machines and is backed up to a storage of a virtualization server, is migrated to an additional second virtualization server, thereby continuously providing a virtualization service and further improving quality of the virtualization service even when a virtualization server connecting with client terminals fails or the client terminal makes a request for change of the virtualization server.

In accordance with an embodiment of the present disclosure, there is provided a high availability system for providing an in-memory based virtualization-service, which comprises client terminals, a connection broker (CB) manager configured to authenticate the client terminals and authorize the client terminals to connect with a virtualization server, and a virtualization server configured to provide a virtualization service to the connected client terminals, wherein the virtualization server comprises a memory in addition to a storage, and a control engine configured to allocate and manage blocks of the storage to each connected client terminal and make each block of the storage store and manage individual data of client virtual machines and the memory store and manage only data shared among the client virtual machines, wherein each connected client terminal is configured to receive the virtualization service through the allocated block of the storage for storing and managing the individual data and the memory for storing and managing only the sharing data, wherein the high availability system further comprises a second virtualization server, to which the client terminal connected to the virtualization server is newly connected under control of the CB manager when the client terminal makes a virtualization-server changing request or when the virtualization server fails, so that the client terminal seamlessly receives the virtualization service as provided by the virtualization server from the second virtualization server, wherein the second virtualization server is provided as a separate virtualization server determined as available and newly assigned by the CB manager, or a separate virtualization server previously configured by dualization of the virtualization server to have high availability, and comprises a memory, which is usable by the client terminal, in addition to a storage, wherein the CB manager controls data related to the client terminal, which has been backed up on the storage of the virtualization server, to migrate to the storage of the second virtualization server when the client terminal connected to the virtualization server makes the virtualization-server changing request or when the virtualization server fails, wherein when the second virtualization server and the virtualization server are dualized having high availability within fault tolerance, the second virtualization server allocates the block of the storage, in which the data related to the client terminal is stored, to the client terminal at a moment when the client terminal is connected to the second virtualization server.

### BRIEF DESCRIPTION OF THE DRAWINGS

The above and/or other aspects of the present disclosure will become apparent and more readily appreciated from the following description of the exemplary embodiments, taken in conjunction with the accompanying drawings, in which:

FIG. 1 illustrates a basic configuration of a high availability system for providing an in-memory based virtualization-service according to one embodiment of the present disclosure;

FIG. 2 is a general block diagram of FIG. 1; and

FIG. 3 is a general block diagram of a high availability system for providing an in-memory based virtualization-service according to another embodiment of the present disclosure.

### DETAILED DESCRIPTION

Below, embodiments of a high availability system for providing an in-memory based virtualization-service according to the present disclosure with the foregoing objects, solutions, and effects will be described in detail with reference to the accompanying drawings.

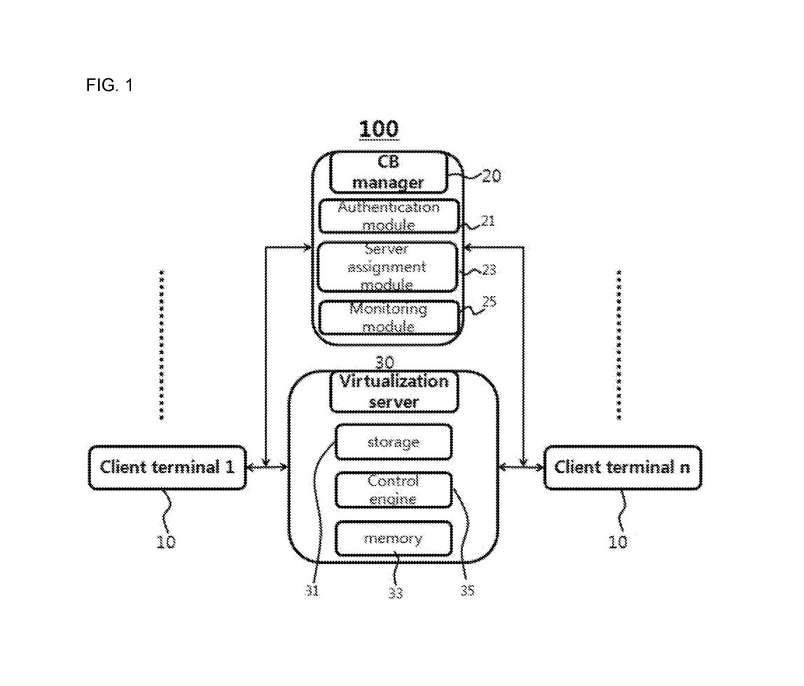

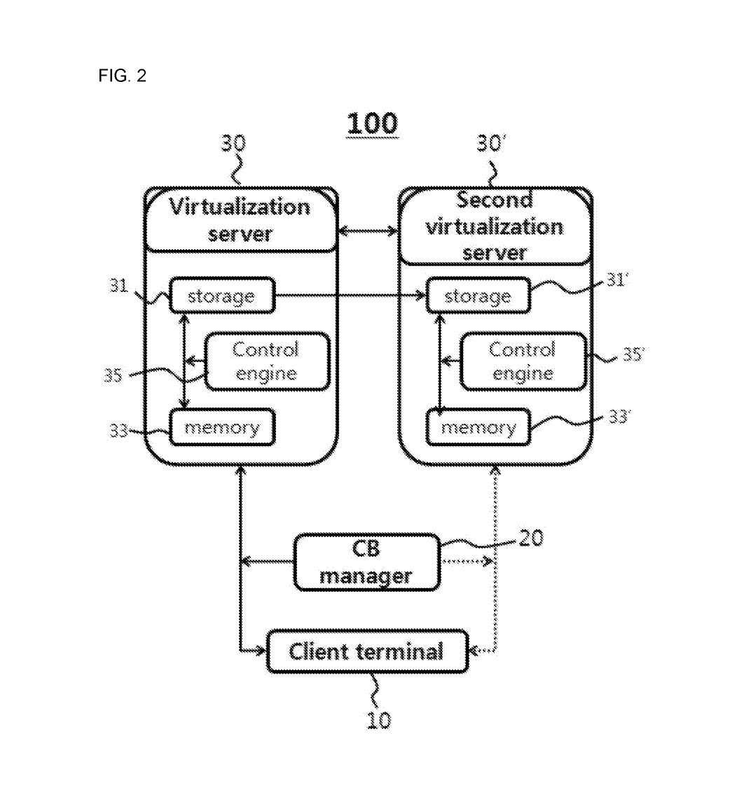

FIG. 1 illustrates a basic configuration of a high availability system for providing an in-memory based virtualization-service according to an embodiment of the present disclosure; and FIG. 2 is a block diagram of a high availability system for providing an in-memory based virtualization-service according to one embodiment of the present disclosure.

As shown in FIGS. 1 and 2, a high availability system 100 for providing an in-memory based virtualization-service according to one embodiment of the present disclosure basically includes a plurality of client terminals 10; a connection broker (CB) manager 20 configured to authenticate the client terminals 10 and authorize the client terminals 10 to access a virtualization server 30; and the virtualization server 30 configured to provide a virtualization service to the accessed client terminals 10 through a virtual machine.

Each individual client terminal 10 employed in this embodiment may receive the virtualization service in not only a storage 31 but also a memory 33 for storing and managing data used in common and shared among the client virtual machines. That is, according to the present disclosure, each individual client terminal 10 connected to the virtualization server may use an allocated block of the storage 31 and the memory 33 to receive the virtualization service. In this regard, detailed descriptions will be made later.

The CB manager 20 employed in this embodiment assigns the virtualization server 30 to the client terminal 10 in response to a user's request, and manages the creation, management, destruction and migration of the virtual machine.

In detail, the CB manager 20 serves to assign the virtualization server 30 to the client terminals 10 in response to a user's request. That is, the CB manager 20 authorizes the client terminal 10 to access the virtualization server and thus allows the client terminal to be connected to the virtualization server.

In more detail, the CB manager 20 may include an authentication module 21 configured to authorize connection between the client terminal 10 and the virtualization server 30 through client authentication; a server assignment module 23 configured to determine the operation state of the virtualization server 30 and assign the virtualization server 30 to the client terminal; and a monitoring module 25 configured to monitor the operation state of the virtualization server 30.

The authentication module 21 serves to check access authority of a user who wants to have an access through his/her login credentials so that only users having the authority can access the virtualization server 30, and permit assignment of a predetermined virtual machine based on virtual machine information of the virtualization server 30 to which the authorized user will access. Further, the server assignment module 23 serves to assign an optimum virtualization server to a client terminal, based on a real-time operation state of the virtualization server 30 from the monitoring module 25.

The monitoring module 25 monitors in real time a resource allocation state and resource use information of the virtualization servers, and whether the created virtual machines are used or not, so that the server assignment module can assign an optimum virtualization server to a client terminal based on the monitoring information.

Meanwhile, the monitoring module 25 checks whether the virtualization server 30 fails or the client terminal 10 makes a request for switching over to another virtualization server. In result, when the failure occurs or when there is a request for replacing the virtualization server, the monitoring module 25 serves to control the client terminal 10 to have an access to a new virtualization server, i.e. a second virtualization server 30′ and at the same time control data to migrate from the first virtualization server 30 to the second virtualization server 30′ when data migration is needed. In this regard, descriptions will be made later.

When each individual client terminal 10 is connected to the virtualization server 30 as authenticated by the CB manager 20, the general virtualization server 30 generates and allocates respective client virtual machines to the connected client terminals 10, and provides a virtualization service through the client virtual machines. In this case, each individual client virtual machine employs each block of the storage 31 allocated to each client terminal 10, and further employs the memory 33 to provide the virtualization service to the client terminals.

The virtualization server 30 employed in this embodiment includes the storage 31 such as a disk. Like a general virtualization service providing system, the storage 31 employed in this embodiment is assigned to and used for the connected client terminals 10. In other words, each of the connected client terminal 10 may be assigned and use each block of the storage 31, of which storing, managing, etc. are controlled under a control engine 35. The storage 31 is configured to store and manage data related to the connected client terminal 10, and back up various pieces of data generated while the virtualization service is provided.

However, because the storage 31 has the disk's own speed-down problem and is much slower in reading and writing data than the memory, the client terminals 10 according to the present disclosure not only use each allocated block of the storage 31 but also the memory 33, which loads, stores, and manages basically used resources and frequently used resources when connection is made, to receive the virtualization service.

Thus, the virtualization server 30 according to the present disclosure includes the memory 33 separately from the storage 31. Further, the virtualization server 30 includes the control engine 35 which is in charge of allocating the blocks of the storage 31, controlling data to be stored and managed, and managing the using and storing of the memory 33. The areas, i.e., the blocks of the memory 33 are allocated to the connected client terminals 10 by the control engine 35.

In brief, the virtualization server 30 includes the memory 33 in addition to the storage 31, and the control engine 35 configured to allocate and manage the blocks of the storage 31 to each connected client terminal 10, and make the client virtual machines' individual data be stored and managed in each block of the storage 31, and make only data shared among the client virtual machines be stored and managed in the memory 33.

The storage 31 is basically configured to store and manage all the pieces of data, i.e. original data related to the connected client terminals 10. That is, the storage 31 is configured to store and manage not only the data shared among the client virtual machines, which is assigned to the client terminals 10 and used in common among the client virtual machines, but also data exclusively used or generated by each individual client virtual machine, i.e., the client virtual machine's individual data.

Here, the data shared among the client virtual machines refers to resource data used or utilized in common by the client virtual machines for the connected client terminals, for example, an operating system (OS), Hangul word processor, Word, PowerPoint, or the like program resources basically or frequently used by connected clients. Further, the client virtual machine's individual data refers to resource data related to only each individual client virtual machine, for example, data processed and generated in each individual terminal, and various programs, files, etc. used in only each of the client terminals.

The control engine 35 allocates a specific area, i.e., a specific block of the storage 31 to each client terminal 10 connected to the virtualization server 30. Therefore, each client terminal 10 connected to the virtualization server 30 can receive a virtualization service through its own allocated block of the storage 31.

However, when the storage 31 is used, the virtualization service may have problems with poor quality, such as a speed-down problem, etc. Therefore, according to the present disclosure, the memory 33 is provided to load and use only common data, which is used in common by the client virtual machines respectively assigned to the client terminals 10, i.e. data shared among the client virtual machines, of original data stored and managed in the storage 31.

To this end, the control engine 35 controls the memory 33 to store and manage only the data shared among the client virtual machines. Therefore, resource data individually generated or exclusively used by the client virtual machines, i.e. the client virtual machines' individual data is stored and managed in not the memory 33 but the blocks of the storage 31 allocated to the client terminals.

The control engine 35 allocates and manages the blocks of the storage 31 to the connected client terminals (i.e. the client virtual machines), so that the client virtual machines' individual data can be stored and managed in the blocks of the storage 31. Eventually, each client virtual machine stores newly generated data or its own data in the allocated block of the storage 31, and loads the individual data from its own block of the storage 31 as necessary to thereby provide the virtualization service.

Like this, the individual data of the client virtual machines is stored and managed in the storage 31, and continuously backed up to be stored and managed in the storage 31 in real time even though it is generated, modified and processed while the virtualization service is provided. Therefore, there is little data loss even when the virtualization server 30 fails, and migration for dualization to have high availability is also performed without data loss, thereby continuously providing the virtualization service with good quality.

However, when the virtualization service is provided by only access to the storage 31, the virtualization service may have poor quality, such as a low speed, etc. Therefore, according to the present disclosure, the data shared among the client virtual machines is loaded onto the memory 33, and then used in common by the client virtual machines. Therefore, each client virtual machine does not always load the data shared among the client virtual machine from the storage 31 but use the sharing data for the client virtual machines loaded into the memory 33, thereby providing the virtualization service without the speed-down problem.

To the end, the control engine 35 loads the sharing data for the client virtual machines from the storage 31, in which the original data is stored and managed, onto the memory 33. When the resource data used in common by the client virtual machines is changed, the control engine 35 modifies the data shared among the client virtual machines, which is stored and managed in the memory 33, by taking the change into account. For example, when a new program is stored and managed in the storage 31 and used in common by the connected client terminals 10, the control engine 35 loads the new program onto the memory 33.

Because the memory 33 is volatile, data is not retained when power is off or when there is malfunction. Therefore, data newly generated or separately used while receiving the virtualization service may be backed up and stored in the storage 31 even though the connected client terminals 10 use the data stored and managed in the memory 33 and shared among the client virtual machines.

Like this, the individual data of each client virtual machine, generated while the virtualization service is provided to the client terminal 10 is backed up on the blocks of the storage 31 respectively allocated to the client virtual machines. Therefore, the data related to the virtualization service provided to the client terminal 10 can be used again in the client terminal 10 by recovery, dualization, migration, or the like process even though the virtualization server 30 fails or access to the virtual server 30 is blocked for various reasons. Further, the virtualization service can be seamlessly provided.

As shown in FIG. 2, the high availability system 100 for providing the in-memory based virtualization-service according to one embodiment of the present disclosure further includes the second virtualization server 30′ so that the client terminal 10 connected to the virtualization server can seamlessly receive the virtualization service when the virtualization server 30 fails or when the client terminal 10 connected to the virtualization server 30 makes a virtualization-server changing request.

Thus, the high availability system 100 for providing the in-memory based virtualization-service according to one embodiment of the present disclosure further includes the second virtualization server 30′ to which the client terminal 10 is connected under control of the CB manager 20 when the client terminal 10 connected to the virtualization server 30 makes a virtualization-server changing request or when the virtualization server 30 fails, so that the client terminal 10 can continuously receive the virtualization service as provided by the virtualization server 30 from the second virtualization server 30′.

Here, the second virtualization server 30′ may refer to a separate virtualization server 30′ determined as available and newly assigned by the CB manager 20, or a separate virtualization server 30′ previously configured by dualization of the virtualization server 30. Further, the second virtualization server 30′ includes a memory 33′, which can be used by the client terminal 10, in addition to a storage 31′.

In detail, the client terminal 10 may make a virtualization-server changing request to the virtualization server 30, and the virtualization server 30 transmits the virtualization-server changing request of the client terminal 10 to the CB manager 20. Then, the CB manager 20 assigns the second virtualization server 30′ to the client terminal 10 so that the client terminal 10 can access the second virtualization server 30′.

The monitoring module 25 of the CB manager 20 may monitor other virtualization servers in real time. Therefore, the monitoring module 25 detects another virtualization server of low usage and high speed, i.e. another available virtualization server and informs the server assignment module 23 of the detected virtualization server. Then, the server assignment module 23 assigns the detected available virtualization server as the second virtualization server 30′ to the client terminal 10 so that the client terminal 10 can access the second virtualization server 30′.

Like this, the second virtualization server 30′ may refer to a separate virtualization server determined as available and newly assigned by the CB manager 20, but is not limited thereto. Alternatively, to more reliably provide a virtualization service without discontinuity, the second virtualization server 30′ may refer to a separate virtualization server previously configured by dualization of the virtualization server 30. That is, the second virtualization server 30′ may be a virtualization server previously configured for the dualization.

Meanwhile, regardless of the virtualization-server changing request of the client terminal 10, the monitoring module 25 of the CB manager 20 may detect a fault in the virtualization server 30 when the virtualization server 30 fails and immediately assign the second virtualization server 30′ to which the client terminal 10 can have an access. Even in this case, it is not much different from when there is the virtualization-server changing request of the client terminal 10, i.e., the CB manager 20 may assign the second virtualization server 30′ to which the client terminal 10 can have an access, and the second virtualization server 30′ may be a separate virtualization server previously configured for dualization or a separate virtualization server determined as available and newly assigned by the CB manager 20.

Here, the second virtualization server 30′ may be a general virtualization server, but may be practically the same as the virtualization server 30 according to the present disclosure. That is, as shown in FIG. 2, the second virtualization server 30′ may include the storage 31′ and the memory 33′ provided separately from the storage 31′ and used by a newly connected client terminal 10.

Ultimately, the second virtualization server 30′ is configured to seamlessly provide the virtualization service as provided by the virtualization server 30 to the client terminal 10 through its own memory 33′. That is, the client terminal 10 newly connected to the second virtualization server 30′ can seamlessly receive the virtualization service through the memory 33′ provided in the second virtualization server 30′.

Like this, to seamlessly receive the virtualization service as provided by the virtualization server 30 through the second virtualization server 30′, the client terminal 10 has to receive data generated and stored in the virtualization server 30. In other words, the second virtualization server 30′ has to receive data related to the client terminal 10 from the virtualization server 30 by migration or have the data related to the client terminal 10 and already stored by the dualization of the virtualization server 30 without discontinuity. In this regard, detailed descriptions will be made below.

First, it will be described on the assumption that there is a virtualization-server changing request of the client terminal 10 connected to the virtualization server 30.

In this case, the CB manager 20 controls the data related to the client terminal 10 (i.e. the client terminal that makes the virtualization-server changing request) to migrate from the virtualization server 30 to the second virtualization server 30′.

In detail, the CB manager 20 controls the data related to the client terminal 10, which has been backed up on the storage 31 of the virtualization server 30, to migrate to the storage 31′ of the second virtualization server 30′. As described above, the data shared among the client virtual machines, which is used in common by the client terminal 10 is loaded onto the memory 33 and its original copy is stored and managed in the storage 31, and each client virtual machine's individual data is also stored, managed and backed up in the storage 31, and therefore the data related to the client terminal 10 (i.e. the sharing data and the individual data) may be migrated from the storage 31 of the virtualization server 30 to the storage 31′ of the second virtualization server 30′.

The CB manager 20 may control the migration of the data related to the client terminal 10 from the storage 31 of the virtualization server 30 to the storage 31′ of the second virtualization server 30′.

The CB manager 20 controls the data related to the client terminal backed up in the storage 31 of the virtualization server 30 to migrate to the storage 31′ of the second virtualization server 30′, and the second virtualization server 30′ allows the client terminal 10 to use the data related to the client terminal 10, which has migrated to and been stored in the storage 31′.

In detail, the second virtualization server 30′ allows the client terminal 10 to use the data related to the client terminal 10, which has migrated to and been stored in the storage 31′, by allocating the blocks of the storage 31′, and at the same time makes the data shared among the client virtual machines, corresponding to the common data, of the data related to the client terminal 10 be uploaded to and stored and managed in the memory (i.e. the memory 33′ of the second virtualization server 30′). Then, the client terminal 10 can seamlessly receive the virtualization service, which has been provided by the virtualization server 30, through the block of the storage 31 allocated by the second virtualization server 30′ and the block of the memory 33′ configured to store and manage only the sharing data.

However, the virtualization service may be continuously provided directly to the client terminal 10 without the migration. To this end, the virtualization server 30 and the second virtualization server 30′ are configured by dualization as described above to have high availability within fault tolerance.

In this case, i.e., when the second virtualization server 30′ and the virtualization server 30 are dualized having high availability within the fault tolerance, the second virtualization server 30′ allocates the block of the storage 31′, in which the data related to the client terminal 10 is stored, to the client terminal at the moment when the client terminal 10 is connected to the second virtualization server 30′.

In detail, when the second virtualization server 30′ and the virtualization server 30 are dualized having high availability within the fault tolerance, the data related to the client terminal 10 and generated in the virtualization server 30 is transmitted to and synchronized with the second virtualization server 30′ in real time. That is, the data related to the client terminal 10 backed up on and stored in the storage 31 of the virtualization server 30 may be transmitted to the second virtualization server 30′ in real time and stored in the storage 31′ of the second virtualization server 30′.

Like this, the virtualization server 30 and the second virtualization server 30′ may be dualized to have high availability within the fault tolerance. In this case, the storage 31 of the virtualization server 30 and the storage 31′ of the second virtualization server 30′ are synchronized.

When the synchronization between the storage 31 of the virtualization server 30 and the storage 31′ of the second virtualization server 30′ is achieved, the second virtualization server 30′ extracts the sharing data for the client virtual machines from the data related to the client terminals 10 synchronized in real time and stored in the storage 31′ so that the extracted sharing data can be loaded on to and stored and managed in the memory 33′

Therefore, when the virtualization server 30 and the second virtualization server 30′ are dualized having high availability within the fault tolerance, the data related to the client terminal 10 and generated in the virtualization server 30 may be stored and managed in the storage 31′ of the second virtualization server 30′ in real time, and at the same time the block of the storage 31′ may be allocated to and used by the client terminal 10. Further, only the sharing data is used by the client terminal 10 as extracted and loaded on to the memory 33′ of the second virtualization server.

Eventually, when the second virtualization server 30′ and the virtualization server 30 are dualized having high availability within the fault tolerance, the client terminal 10 can have an access to the second virtualization server 30′ under control of the CB manager 20 in response to a virtualization-server changing request of the client terminal 10 connected to the virtualization server 30, and the second virtualization server 30′ allocates the block of the storage 31′, in which the data related to the client terminal 10 has been stored, to the client terminal 10. Then, the client terminal 10 can seamlessly receive a virtualization service through the block of the storage 31′ allocated to the second virtualization server 30′.

The storage 31′ of the second virtualization server 30′ is storing the data related to the client terminal, i.e., the data shared among the client virtual machines and the individual data of the client virtual machines. Further, the second virtualization server 30′ extracts the sharing data for the client virtual machines from the storage 31′ of the second virtualization server 30′, which stores the data related to the client terminal received from the storage 31 of the virtualization server 30, and stores the extracted data in the memory 33′ of the second virtualization server 30′. Ultimately, the client terminal 10 can seamlessly receive the virtualization service without the speed-down problem.

The foregoing shows the case where there is a virtualization-server changing request of the client terminal 10 connected to the virtualization server 30. Next, it will be described on the assumption that the virtualization server fails.

Even in this case, the CB manager 20 controls the data related to the client terminal 10 (i.e. the client terminal connected to the virtualization server which fails) to migrate from the virtualization server 30 to the second virtualization server 30′.

In detail, the CB manager 20 controls the data related to the client terminal 10, which has been backed up on the storage 31 of the virtualization server 30 before the virtualization server 30 fails, to migrate to the storage 31′ of the second virtualization server 30′. As described above, the data related to the client terminal is backed up on and stored and managed in the block of the storage 31 allocated to the client terminal, and it is therefore possible to migrate the data related to the client terminal 10 from the storage 31 of the virtualization server 30 to the storage 31′ of the second virtualization server 30′.

The CB manager 20 may perform control the data related to the client terminal 10 to migrate from the storage 31 of the virtualization server 30 to the storage 31′ of the second virtualization server 30′.

The CB manager 20 controls the data related to the client terminal, which has been backed up on the storage 31 of the virtualization server 30, to migrate to the storage 31′ of the second virtualization server 30′.

Then, the second virtualization server 30′ makes the data related to the client terminal 10, which has migrated to and been stored in the storage 31′, be used by the client terminal 10 by allocating the block of the storage 31′ to the client terminal 10, and at the same time makes the sharing data, i.e. the common data for the client virtual machines of the data related to the client terminal 10 be loaded on to and stored and managed in the memory (i.e. the memory 33′ of the second virtualization server 30′). Thus, the client terminal 10 can seamlessly receive the virtualization service, which has been provided by the virtualization server 30, through the memory 33′ for storing and managing only the sharing data and the block of the storage 31′ allocated by the second virtualization server 30′.

Meanwhile, even when the virtualization server 30 fails, it is also possible to seamlessly provide the virtualization service directly to the client terminal 10 without the migration as described above. To this end, the second virtualization server 30′ and the virtualization server 30 are configured by dualization as described above to have high availability within the fault toleration.

Since this configuration is equivalent to that of when the client terminal connected to the virtualization server makes a virtualization-server changing request, repetitive descriptions will be avoided.

As described above, the storage 31 is provided in virtualization server 30, and the second virtualization server 30′ is also internally provided with the separate storage 31′, thereby seamlessly providing the virtualization service.

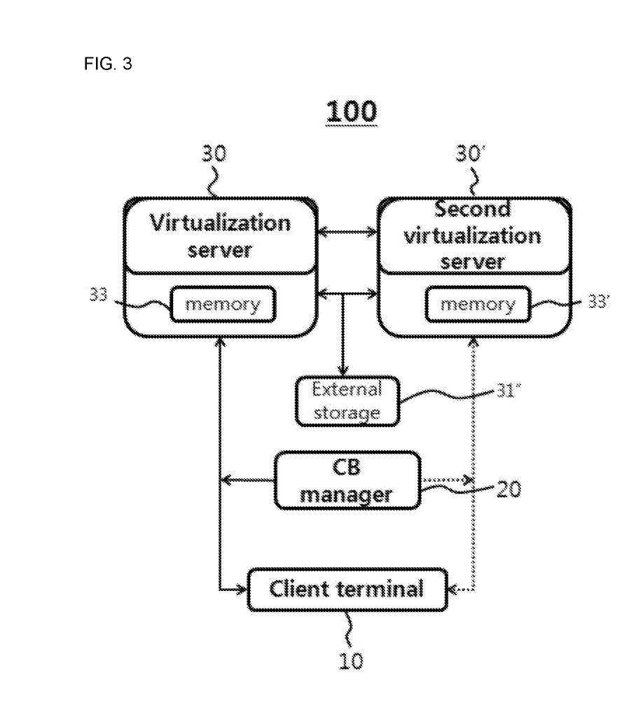

In a high availability system 100 for providing an in-memory based virtualization-service according to another embodiment of the present disclosure, as shown in FIG. 3, the storage of the virtualization server may be provided not internally but externally and may be replaced by an external storage to be shared with another virtualization server.

In a high availability system 100 for providing an in-memory based virtualization-service according to another embodiment of the present disclosure, the storage 31 of the virtualization server 30 is replaced by an external storage 31″ provided separately from the virtualization server; the external storage 31″ is shared between the virtualization server 30 and the second virtualization server 30′; the CB manager 20 controls the client terminal 10 to newly connect with the second virtualization server 30′ and seamlessly receive the virtualization service that has been provided by the virtualization server 30, when the client terminal 10 connected to the virtualization server 30 makes a virtualization-server changing request or when the virtualization server fails; and the second virtualization server 30′ extracts the data shared among the client virtual machines from the external storage 31″ and stores the extracted sharing data in the memory 33′ of the second virtualization server 30′.

The external storage 31″ is used as shared between the virtualization server 30 and the second virtualization server 30′. That is, the virtualization server 30 and the second virtualization server 30′ are configured to store and manage data related to clients in the external storage 31″ so that the client virtual machines can access and use the data, and further make the individual data of the client virtual machine be backed up on and stored and managed in the external storage 31″.

Eventually, when the client terminal connected to the virtualization server makes a virtualization-server changing request or when the virtualization server fails, the CB manager 20 controls the client terminal to newly connect with the second virtualization server 30′ and seamlessly receive the virtualization service that has been provided by the virtualization server 30, like that of the high availability system 100 for providing an in-memory based virtualization-service. However, because the data related to the clients is backed up on and managed by the external storage 31″, the data related to the clients is retained in the external storage 31″ as it is and separate migration is not performed.

Therefore, the second virtualization server 30′ seamlessly using the data related to the client terminal, which has been backed up on and stored and managed in the external storage 31″, in order to provide the virtualization service to the client terminal, and extracts only the data shared among the client virtual machines from the external storage 31″ and makes the extracted data be loaded on to and stored and managed in the memory 33′ of the second virtualization server 30′ so as to just provide the virtualization service without the speed-down problem.

The foregoing high availability system 100 for providing an in-memory based virtualization-service according to a second embodiment of the present disclosure includes the external storage 31″ instead of the storage provided inside the virtualization server in order to provide the virtualization service, thereby seamlessly providing the virtualization service without speed-down and data loss problems under the condition that there are no needs of performing separate migration, even when the virtualization server fails.

As described above, in a high availability system for providing an in-memory based virtualization-service according to the present disclosure with the foregoing technical problems and solutions, data related to a client terminal, which is backed up on a storage of a virtualization server and includes individual data of client virtual machines and data shared among the client virtual machines, is configured to migrate to a separate second virtualization server, thereby seamlessly providing a virtualization service and improving the quality of the virtualization service even when the virtualization server to which the client terminal is connected fails or even when the client terminal makes a virtualization-server changing request.

Although a few exemplary embodiments of the present disclosure have been shown and described, these are for illustrative purpose only and it will be appreciated by those skilled in the art that changes may be made in these embodiments without departing from the principles and spirit of the invention, the scope of which is defined in the appended claims and their equivalents.

1. A high availability system for providing an in-memory based virtualization-service, which comprises client terminals, a connection broker (CB) manager configured to authenticate the client terminals and authorize the client terminals to connect with a virtualization server, and a virtualization server configured to provide a virtualization service to the connected client terminals,
wherein the virtualization server comprises a memory in addition to a storage, and a control engine configured to allocate and manage blocks of the storage to each connected client terminal and make each block of the storage store and manage individual data of client virtual machines and the memory store and manage only data shared among the client virtual machines,
wherein each connected client terminal is configured to receive the virtualization service through the allocated block of the storage for storing and managing the individual data and the memory for storing and managing only the sharing data,
wherein the high availability system further comprises a second virtualization server, to which the client terminal connected to the virtualization server is newly connected under control of the CB manager when the client terminal makes a virtualization-server changing request or when the virtualization server fails, so that the client terminal seamlessly receives the virtualization service as provided by the virtualization server from the second virtualization server,
wherein the second virtualization server is provided as a separate virtualization server determined as available and newly assigned by the CB manager, or a separate virtualization server previously configured by dualization of the virtualization server to have high availability, and comprises a memory, which is usable by the client terminal, in addition to a storage,
wherein the CB manager controls data related to the client terminal, which has been backed up on the storage of the virtualization server, to migrate to the storage of the second virtualization server when the client terminal connected to the virtualization server makes the virtualization-server changing request or when the virtualization server fails,
when the second virtualization server and the virtualization server are dualized having high availability within fault tolerance, the second virtualization server allocates the block of the storage, in which the data related to the client terminal is stored, to the client terminal at a moment when the client terminal is connected to the second virtualization server.

2. The high availability system for providing the in-memory based virtualization-service according to claim 1, wherein the second virtualization server extracts the data shared among the client virtual machines from the storage of the second virtualization server, in which the data related to the client terminal received from the storage of the virtualization server is stored, and stores the extracted sharing data in the memory of the second virtualization server.

3. The high availability system for providing the in-memory based virtualization-service according to claim 1, wherein the storage of the virtualization server is replaced by an external storage provided separately from the virtualization server, the external storage is shared between the virtualization server and the second virtualization server, the CB manager controls the client terminal to newly connect with the second virtualization server and seamlessly receive the virtualization service as provided by the virtualization server when the client terminal connected to the virtualization server makes the virtualization-server changing request or when the virtualization server fails, and the second virtualization server extracts the data shared among the client virtual machines from the external storage and stores the extracted sharing data in the memory of the second virtualization server.

4. The high availability system for providing the in-memory based virtualization-service according to claim 2, wherein the storage of the virtualization server is replaced by an external storage provided separately from the virtualization server, the external storage is shared between the virtualization server and the second virtualization server, the CB manager controls the client terminal to newly connect with the second virtualization server and seamlessly receive the virtualization service as provided by the virtualization server when the client terminal connected to the virtualization server makes the virtualization-server changing request or when the virtualization server fails, and the second virtualization server extracts the data shared among the client virtual machines from the external storage and stores the extracted sharing data in the memory of the second virtualization server.
